(19) United States
(12) Patent Application Publication
(10) Pub. No.: US 2006/0227080 A1
(43) Pub. Date: Oct. 12, 2006

(54) Charge-recycling circuit of display device

(76) Inventors: Cheermore Huang, Hsinchu Science Park (TW); Ironic Yu, Hsinchu Science Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/100,447

(22) Filed: Apr. 7, 2005

(51) Int. Cl. G09G 3/30

(52) U.S. Cl. 345/76

(57) ABSTRACT

The present invention provides a charge-recycling circuit of display device, which is coupled to the connection line between the display panel of the display module and the source driver circuit of the display module. The display module has a source driver circuit and a gate driver circuit, and when the source driver circuit is switched off, the charge-recycling circuit will transfer the charge to an external capacitor. The present invention comprises a charge-transferring circuit, which can transfer the charge stored in the parasitic capacitor of the display panel to an external capacitor element, which is outside the system. Further, a detect/switch element is disposed between the charge-transferring circuit and the source driver circuit to detect the voltage level between the display panel and the charge-transferring circuit in order to determine the conduction state between the charge-transferring circuit and the source driver circuit according to the critical light-emitting voltage of different color layer's display panel. Thereby, the present invention can effectively save the power of the power supply and improve the efficiency of the battery.

### BACKGROUND OF THE INVENTION

1. Field of the Invention

The present invention relates to a circuit structure, particularly to a charge-recycling circuit of display device, which can save power and improve battery efficiency.

2. Description of the Related Art

Recently, the cost of Liquid Crystal Display (LCD) slides down very rapidly, which enables the LCD application to expand fast, and thus, the domination of Cathode Ray Tube (CRT) has been broken by the prosperity of Flat Panel Display (FPD). LCD is the mainstream product currently; however, the products of emerging technologies are entering into market one by one, such as Plasma Display Panel (PDP), Low Temperature Poly-Silicon (LTPS) LCD, Rear Projection Display, etc. Among those, the product of the self-luminous and simple-structured Organic Light-Emitting Diode (OLED) is an outstanding one, which attracts the most attention in the consumption market of electronic products.

The reasons why OLED attracts so much attention include: much lower investment threshold than that of Thin Film Transistor (TFT) Liquid Crystal Display (LCD), the self-luminosity/coloring characteristics of OLED (free of backlight and color filter), reduced cost of display module, reduced thickness of display module (less than 2 mm), higher brightness, less viewing angle limit (viewing angle larger than 165 degree), higher response speed (response time less than 10 μs), lower driving voltage (5˜15V), flexibility (applicable to plastic substrate), and simpler fabrication process. When OLED panel works, it needs a stable power to drive; therefore, the structure of OLED panel usually has a ground circuit to drain the charge once the panel is switched off. However, as the power for driving OLED panel is somewhat appreciable, draining the residual electricity is a waste. The conventional technologies U.S. Pat. No. 6,501,226 “Driving system and method for electroluminescence display” and No. 6,594,606 “Matrix element voltage sensing for pre-charge” have mentioned that utilizing arrayed anode leads and cathode leads connecting with the power supply can enable the voltage to be recycled and the switching voltage to be lowered. However, the texts of those patents only mentions “voltage recycling” and does not disclose how to store the voltage or apply the voltage to elements other than the power switch. Thus, to compromise among saving energy, recycling power, and protecting circuit is a problem the manufacturers desiring to overcome.

Therefore, the present invention proposes a charge-recycling circuit of display device to solve the aforementioned problems.

### SUMMARY OF THE PRESENT INVENTION

The primary objective of the present invention is to provide a charge-recycling circuit of display device, wherein the drained charge is stored into an external capacitor for use inside the display device so that the objective of saving power in OLED display device can be achieved.

Another objective of the present invention is to provide a charge-recycling circuit of display device, which provides power for the active elements inside the display device so that the utilization efficiency of the power supply of the display device can be promoted.

To achieve the aforementioned objectives, the charge-recycling circuit of display device of the present invention is coupled to the connection line between the display panel of the display module and the source driver circuit of the display module. The display module has a source driver circuit and a gate driver circuit, and when the source driver circuit is switched off, the charge-recycling circuit will transfer charge to an external capacitor, which is outside the system. The present invention comprises a charge-transferring circuit, which can transfer the charge stored in the parasitic capacitor of the display panel to an external capacitor element outside the system. Further, a detect/switch element is disposed between the charge-transferring circuit and the source driver circuit to detect the voltage level between the display panel and the charge-transferring circuit in order to determine the conduction state between the charge-transferring circuit and the source driver circuit according to the critical light-emitting voltage of different color layer's the display panel.

The embodiments of the present invention are described below in detail in cooperation with the attached drawings to enable the objectives, technical contents, accomplishments of the present invention to be more easily understood.

### BRIEF DESCRIPTION OF THE DRAWINGS

FIG. 1 is the schematic circuit diagram according to one aspect of the present invention.

FIG. 2 is the schematic diagram of the circuitry with the charge-transferring circuit comprising transistors according to one aspect of the present invention.

FIG. 3 is the schematic circuit diagram showing the present invention's application to the display panel with multiple-color layers according to one aspect of the present invention.

FIG. 4 is another schematic circuit diagram showing the present invention's application to the display panel with multiple-color layers according to one aspect of the present invention.

### DETAILED DESCRIPTION OF THE INVENTION

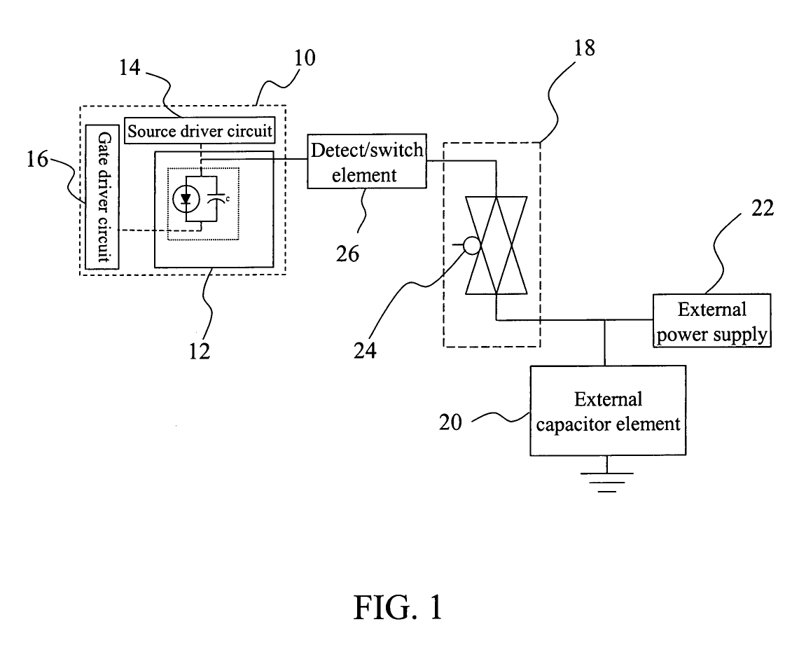

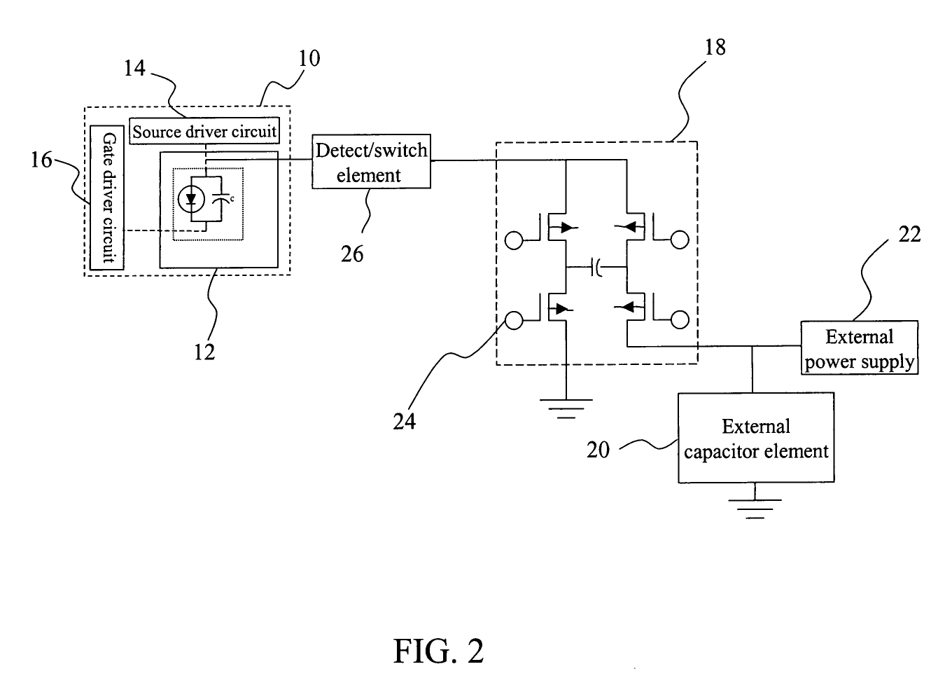

The present invention is a charge-recycling circuit of display device. As showing in FIG. 1, the charge-recycling circuit is coupled to the connection line between the display panel 12 of the display module 10 and the source driver circuit 14 of the display module 10. The display panel 12 is an electroluminescent one, such as Organic Light Emitting Diode (OLED) type or Polymer Organic Light Emitting Diode (POLED) type display panel. The display module 10 has a source driver circuit 14, a gate driver circuit 16, and a display panel 12. When the power of the display module 10 is off, the parasitic capacitor of the display panel 12 will drain charge to the ground line of the display module 10. The present invention comprises a charge-transferring circuit 18, which can transfer the charge stored in the parasitic capacitor of the display panel 12 to an external capacitor element 20, which is outside the system. The charge stored in the external capacitor element 20 can be provided for the active elements inside the display device so that the external power supply 22, which provides power for the display device, can save power more effectively. Further, the charge-transferring circuit 18 also has a ground line, which can drains the charge when the external capacitor element 20 cannot drain the charge. As shown in FIG. 2, the charge-transferring circuit 18 can be formed of multiple transistors and has multiple pre-drivers 24, which control the switching of the transistors in order to determine the direction to which the charge is to be guided.

The charge-recycling circuit comprises a detect/switch element 26, which is disposed between the charge-transferring circuit 18 and the source driver circuit 14 and has a set voltage value that is also the critical light-emitting voltage value of the display panel 12. The detect/switch element 26 will become conductive when the voltage between the display panel 12 and the source driver circuit 14 is greater than the critical light-emitting voltage, i.e. the detect/switch element 26 determines the conduction state between the charge-transferring circuit 18 and the source driver circuit 14 according to the voltage of the display panel 12. When the detect/switch element 26 becomes conductive, it will inform the charge-transferring circuit 18; for example, it will inform at least one pre-driver 24, and the pre-driver 24 will then control the direction to which the charge is to be guided by the charge-transferring circuit 18. Thus, the operation of the charge-recycling circuit of display device is completed.

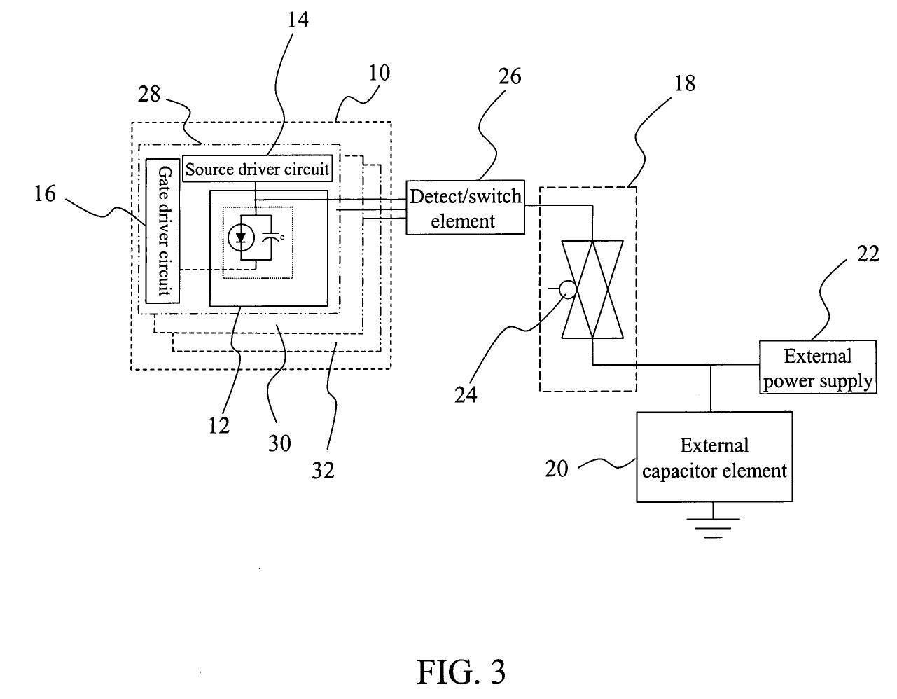

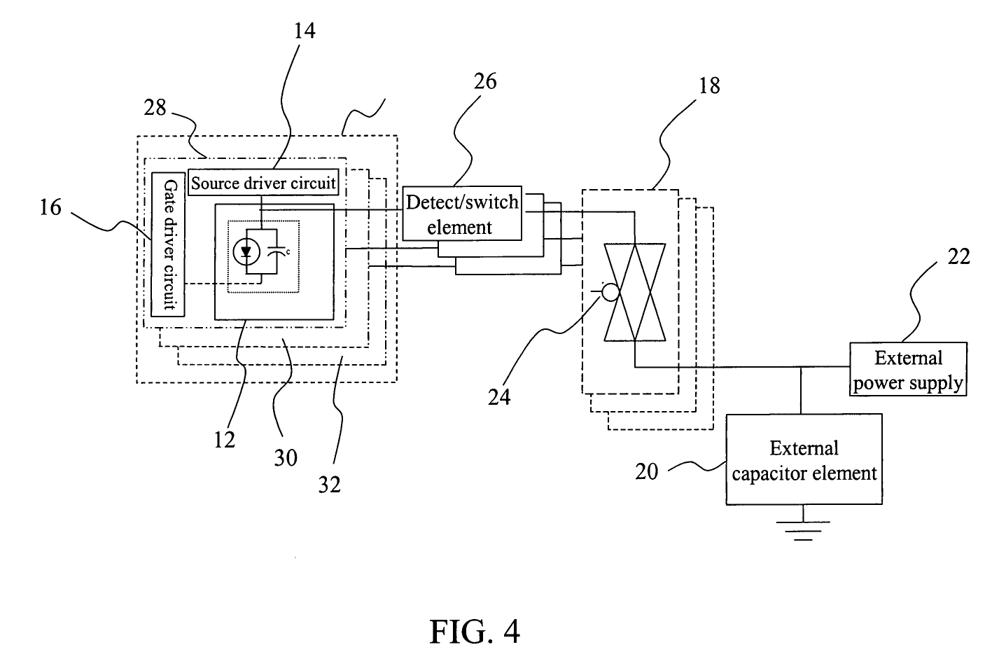

As shown in FIG. 1 and FIG. 2, the aforementioned embodiments relate to the monochrome display module 10, and the colored display module 10 comprises at least red, green, and blue display modules 28, 30, and 32 of three primary colors to control the action of each primary color. As shown in FIG. 3 and FIG. 4, each primary-color layer of red, green, and blue display modules 28, 30, and 32 is separately controlled by corresponding red, green, or blue source driver circuit 14 and red, green, or blue source gate driver circuit 16. Herein, the primary-color layers of red, green, and blue display modules 28, 30, and 32 of the colored display module 10 utilize a common detect/switch element 26 and a common charge-transferring circuit 18, and the common detect/switch element 26 guides the charge of the parasitic capacitor of each color layer's display panel by turns. Further, each color layer of red, green, and blue display modules 28, 30, and 32 can also separately connects to an individual detect/switch element 26 and an individual charge-transferring circuit 18, and the charge is guided to and stored into at least one external capacitor element 20.

In the present invention, the charge is guided to and stored into the external capacitor element 20, and the stored charge can be provided for other active elements of the display device, and thus, the burden of the external power supply 22 can be reduced, and utilization efficiency of the external power supply 22 is then promoted. The present invention stores and utilizes the charge, which is originally to be drained out, and achieves the efficacy of power saving.

What is claimed is:

1. A charge-recycling circuit of display device, which is coupled to a display panel and a source driver circuit of a display module, wherein said display panel comprises at least one driver module and said driver module drains charge to an external capacitor outside the system when said driver module is switched off, comprising:
a charge-transferring circuit, which guides the charge of said driver module to be stored into said external capacitor; and
a detect/switch element, which is disposed between said charge-transferring circuit and said source driver circuit, and controls the conduction between said charge-transferring circuit and said source driver circuit according to the voltage between said display panel and said source driver circuit.

2. The charge-recycling circuit of display device according to claim 1, wherein when said detect/switch element becomes conductive, a pre-driver is informed, and said pre-driver controls the direction, to which said charge-transferring circuit guides the charge.

3. The charge-recycling circuit of display device according to claim 1, wherein when said display panel is a colored one having at least two primary colors, said display panel has at least two said driver modules, and each of said driver modules separately controls the action of each corresponding primary color, and said driver modules utilize a common said detect/switch element and a common said charge-transferring circuit or each of driver modules is coupled to an individual said detect/switch element and an individual said charge-transferring circuit.

4. The charge-recycling circuit of display device according to claim 3, wherein said detect/switch guides the charge of each driver module by turns.

5. The charge-recycling circuit of display device according to claim 1, wherein when said display panel is a colored one having at least two primary colors, said display panel has at least two said driver modules, and each of said driver modules separately controls the action of each corresponding primary color, and said driver modules utilize a common said detect/switch element and a common said charge-transferring circuit or each of driver modules is coupled to an individual said detect/switch element and an individual said charge-transferring circuit, and the charge is guided to and stored into at least one said external capacitor element.

6. The charge-recycling circuit of display device according to claim 1, wherein said charge-transferring circuit comprises a plurality of transistors.

7. The charge-recycling circuit of display device according to claim 1, wherein the charge stored in said external capacitor element is provided for the active elements inside said display device.

8. The charge-recycling circuit of display device according to claim 1, wherein said detect/switch element determines whether to conduct according to whether the voltage between said display panel and said source driver circuit is larger than a voltage value set in said detect/switch element.

9. The charge-recycling circuit of display device according to claim 1, wherein said voltage value set in said detect/switch element is a critical value of light emitting and switching of said driver module.

10. The charge-recycling circuit of display device according to claim 1, wherein said display panel is an electroluminescent display panel.

11. The charge-recycling circuit of display device according to claim 10, wherein said electroluminescent display panel includes an organic light emitting diode (OLED) type one or a polymer organic light emitting diode (POLED) type one.
